(19) United States
(12) Patent Application Publication
(10) Pub. No.: US 2003/0061032 A1
(43) Pub. Date: Mar. 27, 2003

(54) Selective sound enhancement

(75) Inventor: Aleksandr L. Gonopolskiy, Southfield, MI (US)

Correspondence Address: BROOKS & KUSHMAN, 1000 TOWN CENTER 22ND FL, SOUTHFIELD, MI, 48075

(73) Assignee: Clarity, LLC, Troy, MI

(21) Appl. No.: 10/253,684

(22) Filed: Sep. 24, 2002

Related U.S. Application Data
(60) Provisional application No. 60/324,837, filed on Sep. 24, 2001.

(51) Int. Cl. G10L 19/00

(52) U.S. Cl. 704/200.1

(57) ABSTRACT

Two microphones, or sets of microphones, pointed in different directions are used to generate filter parameters based on correlation and coherence of signals received from the microphones. First signals are obtained from sound received by at least one first microphone. Each first microphone receives sound from a first set of directions including a first principal sensitivity direction. The desired sound direction is included in the first set of directions. Second signals are obtained from sound received by at least one second microphone. Each second microphone receives sound from a second set of directions including a second principal sensitivity direction different than the first principal sensitivity direction. The desired sound direction is included in the second set of directions. Filter coefficients are determined based on coherence of the first signals and the second signals and on correlation between the first signals and the second signals. A combination of the first signals and the second signals is filtered with the determined filter coefficients.

### CROSS-REFERENCE TO RELATED APPLICATIONS

This application claims the benefit of U.S. provisional application Serial No. 60/324,837 filed Sep. 24, 2001, which is herein incorporated by reference in its entirety.

### BACKGROUND OF THE INVENTION

1. Field of the Invention

The present invention relates to detecting and enhancing desired sound, such as speech, in the presence of noise.

2. Background Art

Many applications require determining clear sound from a particular direction with sounds originating from other directions removed to a great extent. Such applications include, voice recognition and detection, man-machine interfaces, speech enhancement, and the like in a wide variety of products including telephones, computers, hearing aids, security, and voice activated control.

Spatial filtering may be an effective method for noise reduction when it is designed purposefully for discriminating between multiple signal sources based on the physical location of the signal sources. Such discrimination is possible, for example, with directive microphone arrays. However, conventional beamforming techniques used for spatial filtering suffer from several problems. First, such techniques require large microphone spacing to achieve an aperture of appropriate size. Second, such techniques are more applicable to narrowband signals and do not always result in adequate performance for speech, which is a relatively wideband signal.

What is needed is speech enhancement providing both good performance for speech and a small size.

### SUMMARY OF THE INVENTION

The present invention uses inputs from two microphones, or sets of microphones, pointed in different directions to generate filter parameters based on correlation and coherence of signals received from the microphones.

A method of enhancing desired sound coming from a desired sound direction is provided. First signals are obtained from sound received by at least one first microphone. Each first microphone receives sound from a first set of directions including a first principal sensitivity direction. The desired sound direction is included in the first set of directions. Second signals are obtained from sound received by at least one second microphone. Each second microphone receives sound from a second set of directions including a second principal sensitivity direction different than the first principal sensitivity direction. The desired sound direction is included in the second set of directions. Filter coefficients are determined based on coherence of the first signals and the second signals and on correlation between the first signals and the second signals. A combination of the first signals and the second signals is filtered with the determined filter coefficients.

In an embodiment of the present invention, neither the first principal sensitivity direction nor the second principal sensitivity direction is the same as the desired sound direction.

In another embodiment of the present invention, the angular offset between the desired sound direction and the first principal sensitivity direction is equal in magnitude to the angular offset between the desired sound direction and the second principal sensitivity direction.

In still another embodiment of the present direction, filter coefficients are found by determining coherence coefficients based on the first signals and on the second signals, determining a correlation coefficient based on the first signals and on the second signals and then scaling the coherence coefficients with the correlation coefficient.

In yet another embodiment of the present invention, the first signals and the second signals are spatially filtered prior to determining filter coefficients. This spatial filtering may be accomplished by subtracting a delayed version of the first signals from the second signals and by subtracting a delayed version of the second signals from the first signals.

In a further embodiment of the present invention, the desired sound comprises speech.

A system for recovering desired sound received from a desired sound direction is also provided. A first set of microphones, having at least one microphone, is aimed in a first direction. The first set of microphones generates first signals in response to received sound including the desired sound. A second set of microphones, having at least one microphone, is aimed in a second direction different than the first direction. The second set of microphones generates second signals in response to received sound including the desired sound. A filter estimator determines filter coefficients based on coherence of the first signals and the second signals and on correlation between the first signals and the second signals. A filter filters the first signals and the second signals with the determined filter coefficients.

A method for generating filter coefficients to be used in filtering a plurality of received sound signals to enhance desired sound is also provided. First sound signals are received from a first set of directions including the desired sound direction. Second sound signals are received from a second set of directions including the desired sound direction. The second set of directions includes directions not in the first set of directions. Coherence coefficients are determined based on the first sound signals and the second sound signals. Correlation coefficients are determined based on the first sound signals and the second sound signals. The filter coefficients are generated by scaling the coherence coefficients with the correlation coefficients.

### BRIEF DESCRIPTION OF THE DRAWINGS

FIG. 1 is a schematic diagram illustrating two microphone patterns with varying directionality that may be used in the present invention;

FIG. 2 is a schematic diagram illustrating multiple microphones used to generate varying directionality that may be used in the present invention;

FIG. 3 is a block diagram illustrating an embodiment of the present invention;

FIG. 4 is a block diagram illustrating filter coefficient estimation according to an embodiment of the present invention;

FIG. 5 is a block diagram illustrating spatially filtering according to an embodiment of the present invention; and

FIG. 6 is a schematic diagram illustrating microphones arranged to receive a plurality of desired sound signals according to an embodiment of the present invention.

### DETAILED DESCRIPTION OF THE PREFERRED EMBODIMENT(S)

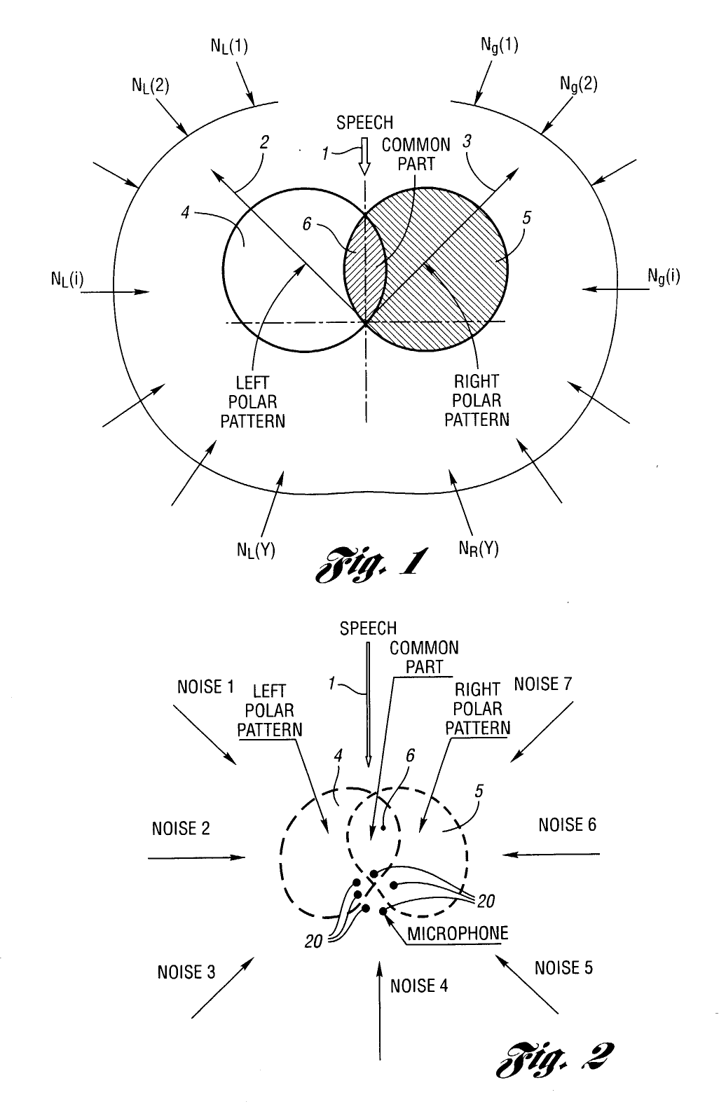

Referring to FIG. 1, a schematic diagram illustrating two microphone patterns with varying directionality that may be used in the present invention is shown. The present invention takes advantage of the directivity patterns that emerge as two or more microphones with varying directional pickup patterns are positioned to select one or more signals arriving from specific directions.

FIG. 1 illustrates one example of two microphones with varying directionality. In the following discussion, one or both of the microphones may be replaced with a group of microphones. Similarly, more than two directions may be considered either simultaneously or by selecting two or more from many directions supported by a plurality of microphones.

Consider two microphones arranged to select signals that arrive from the signal direction 1 and multiple noise sources arriving from other sources. The left microphone has major direction of sensitivity 2 and the right microphone has major direction of sensitivity 3. The left microphone has a polar response plot illustrated by 4 and the right microphone has a polar response plot illustrated by 5. Region 6 indicates the joint response area to speech direction 1 of the left and right microphones.

Each of a plurality of noise sources is labeled N_{X}(j), where X defines the direction (Left or Right) and j is the number assigned. Note that these need not be the actual physical noise sources. Each N_{X}(j) may be, for example, approximations of noise signals that arrive at the microphones. All sources of sound are hypothesized to be independent sources if received from different locations.

The system illustrated in FIG. 1 indicates that both microphones will pick up essentially the same rendition of the signal from direction 1 but different renditions of noise. Left microphone signals (M_{L}) and right microphone signals (M_{R}) can be represented as follows:

$${M}_{L} = {Speech}_{L} + {\sum }_{j} {N}_{L} ( j )$$

$${M}_{R} = {Speech}_{R} + {\sum }_{j} {N}_{R} ( j )$$

where Speech_{L} is the rendition of speech registered at the left microphone or microphone group and Speech_{R} is the rendition of speech registered at the right microphone or the microphone group. Note that the speech signal itself (and therefore thus both the left and the right rendition of it) arrives from speech direction 1 and that the summed noises N_{L} and N_{R} constitute sounds that arrive from left and right directions respectively.

FIG. 2 shows an embodiment of the invention using multiple groups of microphones. Sets of microphones 20 may be used to achieve greater directionality. Further, multiple microphones 20 or groups of microphones 20 may be used to select from which direction 1 speech will be obtained.

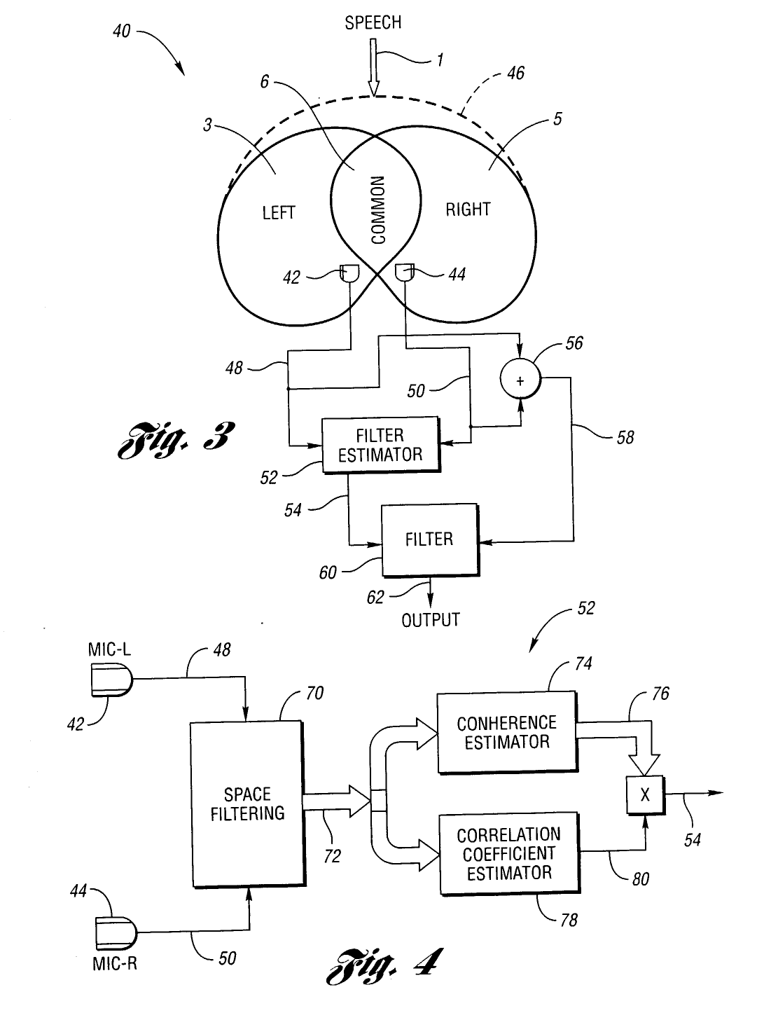

Referring now to FIG. 3, a block diagram illustrating an embodiment of the present invention is shown. A speech acquisition system, shown generally by 40, includes at least two microphones or groups of microphones. In the example illustrated, left microphone 42 has response pattern 3 and right microphone 44 has response pattern 5. Overlap region 6 of microphones 42, 44 generates combined response pattern 46 in speech direction 1.

Left microphone 42 generates left signal 48. Right microphone 44 generates right signal 50. Filter estimator 52 receives left signal 48 and right signal 50 and generates filter coefficients 54. Summer 56 sums left signal 48 and right signal 50 to produce sum signal 58. Filter 60 filters sum signal 58 with filter coefficients 54 to produce output signal 62 which has speech from direction 1 with reduced impact from uncorrelated noise from directions other than direction 1.

Referring now to FIG. 4, a block diagram illustrating filter coefficient estimation according to an embodiment of the present invention is shown. Filter estimator 52 includes space filter 70 receiving left signal 48 from left microphone 42 and right signal 50 from right microphone 44. Space filter 70 generates filtered signals 72 which may include at least one signal which contains a higher proportion of noise or higher proportion of signal than at least one of the microphone signals 48, 50. Space filter 70 may also generate filtered signals 72 containing greater content from a particular subset of the noise sources in the environment or noise sources originating from a particular set of directions with respect to microphones 42, 44.

Coherence estimator 74 receives at least one of filtered signals 72 and generates coherence coefficients 76. Correlation coefficient estimator 78 receives at least one of filtered signals 72 and generates at least one correlation coefficient 80. Filter coefficients 54 are based on coherence coefficients 76 and correlation coefficient 80. In the embodiment shown, coherence coefficients 76 are scaled by correlation coefficient 80.

A mathematical implementation of an embodiment of the present invention is now provided. The presumption is that summed noises N_{L} and N_{R} are not coherent whereas renditions by left microphone 44 (Speech_{L}) and right microphone 48 (Speech_{R}) are coherent. This permits the construction of an optimal filter based on a coherence function to maximize the signal-to-noise ratio between the desired speech signal and summed noises N_{L} and N_{R}.

A coherence function of two signal X and Y may be defined as follows:

$$Coh ( ω ) = \frac{{( ⟨ {S}_{xy} ( ω ) ⟩ )}^{2}}{⟨ {( {S}_{x} ( ω ) )}^{2} ⟩ \cdot ⟨ {( {S}_{y} ( ω ) )}^{2} ⟩}$$

where Sₓ(ω)and S_{y}(ω) are complex Fourier transformations of signals X and Y;

S_{xy}(ω) is a complex cospectrum of signal X and Y; and

(*) is a frame-by-frame symbol average.

The spectrums S_{L}(ω) and S_{R}(ω) may be defined in terms of the complex spectrum of speech S_{Sp}(ω) and the complex spectra of the summed noises, S_{NL}(ω) for summed N_{L} and S_{NR}(ω) for summed N_{R}. Thus, the Fourier transforms for the left and right channels may be expressed as follows:

S_{L}(ω)=S_{Sp}(ω)+S_{NL}(ω)

S_{R}(ω)=S_{Sp}(ω)+S_{NR}(ω)

The squared magnitude spectrum is then as follows:

S_{L}²(ω)=S_{Sp}²(ω)+S_{NL}²(ω)

S_{R}²(ω)=S_{Sp}²(ω)+S_{NR}²(ω)

The complex cospectrum of the left and right channels may be expressed as follows:

S_{LR}(ω)=S_{Sp}²(ω)+S_{Sp}(ω)·\overline{S_{NR}(ω)}+S_{NL}(ω)·\overline{S_{Sp}(ω)}+S_{NL}(ω)·\overline{S_{NR}(ω)}

Because Sₚ, N_{L} and N_{R} are independent sources, the following inequality holds for each of the products:

<S_{Sp}(ω)·\overline{S_{NR}(ω)}>,<S_{NL}(ω)·\overline{S_{Sp}(ω)}<and <S_{NL}(ω)·\overline{S_{NR}(ω)}><<S_{Sp}²(ω)>.

Furthermore, Coh_{LR} (ω)→1 in frequency band ω occupied by speech when the power of speech in that band is significant. However, when there is no speech, COh_{LR}(ω) is between zero and one.

In speech frequency bands, given small distances between microphones 20 and groups of microphones 20, coherence during periods of silence (i.e., when there is no speech present) may approach 1: Coh_{LR} (ω)˜1. Therefore, although the coherence function may have good optimal filtration for speech during periods of speech, it may offer little help for reducing noise during silence periods. For reducing noise during silence periods a correlation coefficient may be used.

The correlation coefficient of two signals X and Y may be defined as follows:

$$Ccorr = \frac{COV ( X , Y )}{VAR ( X ) \cdot VAR ( Y )}$$

where COV represents covariance and VAR represents variance.

When using the frequency domain, the average in an FFT frame may be used. The time correlation coefficient, Ccorr(k), is defined as follows:

$$Ccorr ( k ) = \frac{{( \frac{1}{N - 1} {\sum }_{ω} {S}_{LR} ( ω ) )}^{2}}{( \frac{1}{N - 1} {\sum }_{ω} {S}_{L}^{2} ( ω ) ) \cdot ( \frac{1}{N - 1} {\sum }_{ω} {S}_{R}^{2} ( ω ) )}$$

where k is the number of the frame used (or its discreet time equivalent), and N is the number of samples in each frame. Furthermore,

$${\sum }_{ω} {S}_{LR} ( ω ) = {\sum }_{ω} Re ( {S}_{LR} ( ω ) ) + ⅈ \cdot {\sum }_{ω} Im ( {S}_{LR} ( ω ) )$$

and

S_{LR}(ω)=S_{Sp}²(ω)+S_{Sp}(ω)·\overline{S_{NR}(ω)}+S_{NL}(ω)·\overline{S_{Sp}(ω)}+S_{NL}(ω)·\overline{S_{NR}(ω)}.

Thus, during times of speech Ccorr(k)→1 land during silence periods Ccorr(k)→0.

In an embodiment of this invention, the estimation filter in frame k, G(ω,k), can be obtained by using a product of Ccorr(k) and Coh(ω,k), as follows:

G(ω,k)=Coh(ω,k)·Ccorr(k)

Another method for obtaining Ccorr(k), which involves averaging over multiple frames (M), is as follows:

$$Ccorr ( k ) = \frac{1}{M - 1} {\sum }_{m = k}^{k + M} Ccorr ( m )$$

In this case as well,

G(ω,k)=Coh(ω,k)·Ccorr(k).

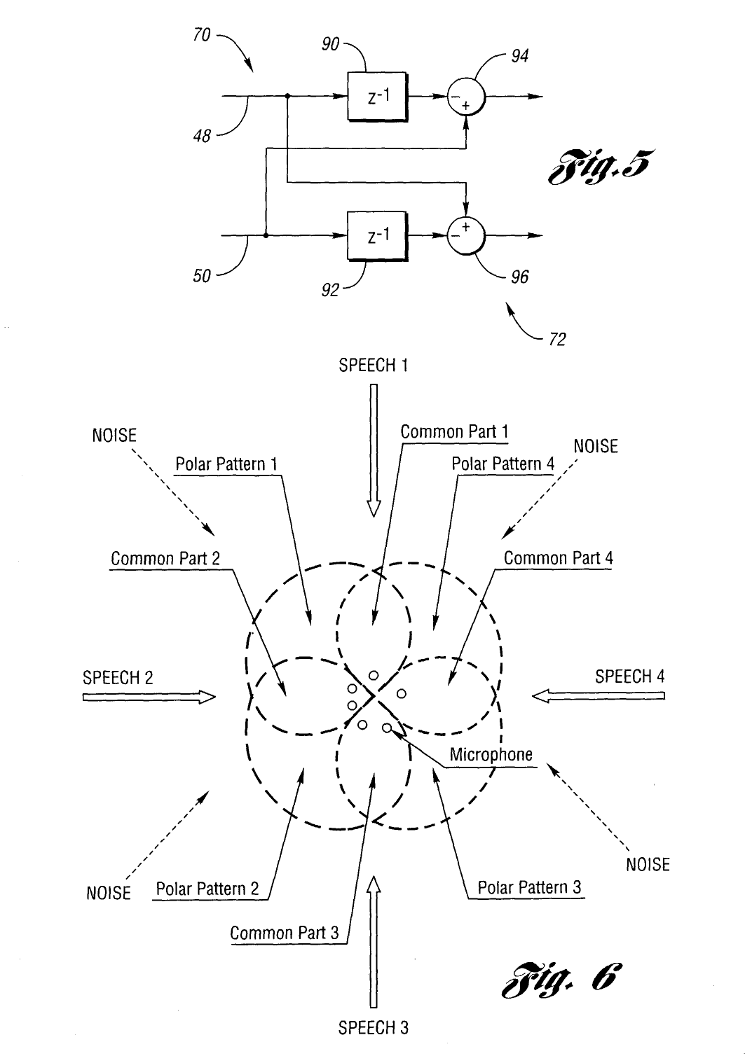

Referring now to FIG. 5, a block diagram illustrating spatially filtering according to an embodiment of the present invention is shown. Space filter 70 accepts left signal 48 and right signal 50. Left signal is delayed in block 90. Right signal 50 is delayed in block 92. Subtractor 94 generates the difference between right signal 50 and delayed left signal 48. Subtractor 96 generates the difference between left signal 48 and delayed right signal 50. Thus, one filtered signal 72 contains the speech signal superimposed by the left hand side noise sources and the other contains the speech signal superimposed by the right hand side noise sources.

Referring now to FIG. 6, a schematic diagram illustrating microphones arranged to receive a plurality of desired sound signals according to an embodiment of the present invention is shown. Multiple sounds arriving from multiple directions can be obtained using two or more groups of microphones. Four groups are shown, which can be directed towards four speech sources of interest.

While embodiments of the invention have been illustrated and described, it is not intended that these embodiments illustrate and describe all possible forms of the invention. For example, while speech has been used as an example in the description, any source of sound may be enhanced by the present invention. The words used in the specification are words of description rather than limitation, and it is understood that various changes may be made without departing from the spirit and scope of the invention.

What is claimed is:

1. A method of enhancing desired sound coming from a desired sound direction, the method comprising:
obtaining first signals from sound received by at least one first microphone, each first microphone receiving sound from a first set of directions including a first principal sensitivity direction, the desired sound direction included in the first set of directions;
obtaining second signals from sound received by at least one second microphone, each second microphone receiving sound from a second set of directions including a second principal sensitivity direction different than the first principal sensitivity direction, the desired sound direction included in the second set of directions;
determining filter coefficients based on coherence of the first signals and the second signals and on correlation between the first signals and the second signals; and
filtering a combination of the first signals and the second signals with the determined filter coefficients.

2. A method of enhancing desired sound as in claim 1 wherein the first principal sensitivity direction is not the same as the desired sound direction and wherein the second principal sensitivity direction is not the same as the desired sound direction.

3. A method of enhancing desired sound as in claim 1 wherein an angular offset between the desired sound direction and the first principal sensitivity direction is equal in magnitude to the angular offset between the desired sound direction and the second principal sensitivity direction.

4. A method of enhancing desired sound as in claim 1 wherein determining filter coefficients comprises:
determining coherence coefficients based on the first signals and on the second signals;
determining a correlation coefficient based on the first signals and on the second signals; and
scaling the coherence coefficients with the correlation coefficient.

5. A method of enhancing desired sound as in claim 1 further comprising spatially filtering the first signals and the second signals prior to determining filter coefficients.

6. A method of enhancing desired sound as in claim 5 wherein space filtering comprises subtracting a delayed version of the first signals from the second signals and subtracting a delayed version of the second signals from the first signals.

7. A method of enhancing desired sound as in claim 1 wherein the desired sound comprises speech.

8. A system for recovering desired sound received from a desired sound direction, the system comprising:
a first set of microphones aimed in a first direction, the first set of microphones comprising at least one microphone, the first set of microphones generating first signals in response to received sound including the desired sound;
a second set of microphones aimed in a second direction different than the first direction, the second set of microphones comprising at least one microphone, the second set of microphones generating second signals in response to received sound including the desired sound;
a filter estimator in communication with the first set of microphones and the second set of microphones, the filter estimator determining filter coefficients based on coherence of the first signals and the second signals and on correlation between the first signals and the second signals; and
a filter in communication with the filter estimator, the first set of microphones and the second set of microphones, the filter filtering the first signals and the second signals with the determined filter coefficients.

9. A system for recovering desired sound as in claim 8 wherein the first direction is different than the desired sound direction and wherein the second direction is different than the desired sound direction.

10. A system for recovering desired sound as in claim 8 wherein the desired sound direction is substantially centered between the first direction and the second direction.

11. A system for recovering desired sound as in claim 8 wherein the filter estimator comprises:
a spatial filter generating filtered signals by spatially filtering the first signals and the second signals;
a coherence estimator generating coherence coefficients based on the filtered signals;
a correlation coefficient estimator generating a correlation coefficient based on the filtered signals; and
a scalar generating the filter coefficients by scaling the coherence coefficients with the correlation coefficient.

12. A system for recovering desired sound as in claim 11 wherein the correlation coefficient is determined as an average over a plurality of frames.

13. A system for recovering desired sound as in claim 11 wherein the spatial filter generates filtered signals by subtracting delayed first signals from second signals and by subtracting delayed second signals from first signals.

14. A system for recovering desired sound as in claim 8 wherein the desired sound comprises speech.

15. A method for generating filter coefficients to be used in filtering a plurality of received sound signals to enhance desired sound from a desired sound direction contained in each sound signal, the method comprising:
receiving first sound signals from a first set of directions including the desired sound direction;
receiving second sound signals from a second set of directions including the desired sound direction, the second set of directions including directions not in the first set of directions;
determining coherence coefficients based on the first sound signals and the second sound signals;
determining correlation coefficients based on the first sound signals and the second sound signals; and
generating the filter coefficients by scaling the coherence coefficients with the correlation coefficients.

16. A method for generating filter coefficients as in claim 15 further comprising spatially filtering the first sound signals and the second sound signals prior to determining coherence coefficients and determining correlation coefficients.

17. A method for generating filter coefficients as in claim 16 wherein spatial filtering comprising:
buffering the first sound signals;
buffering the second sound signals;
obtaining the difference between the first sound signals and the buffered second sound signals; and
obtaining the difference between the second sound signals and the buffered first sound signals.

18. A method for generating filter coefficients as in claim 15 wherein determining correlation coefficients comprises averaging correlation coefficients over a plurality of sampling frames.

19. A method for generating filter coefficients as in claim 15 wherein the desired sound comprises speech.
